(19) United States
(12) Patent Application Publication
(10) Pub. No.: US 2026/0154807 A1
(43) Pub. Date: Jun. 4, 2026

(54) METHOD AND SYSTEM FOR PREDICTING DRYING BEHAVIOR OF DROPLETS

(71) Applicants: Samsung Display Co., LTD., Yongin-si (KR); POSTECH Research and Business Development Foundation, Pohang-si (KR)

(72) Inventors: Dongjin Kang, Yongin-si (KR); Seongju Kim, Pohang-si (KR); Sungjune Jung, Pohang-si (KR); Youngmo Koo, Yongin-si (KR)

(21) Appl. No.: 19/402,325

(22) Filed: Nov. 26, 2025

(30) Foreign Application Priority Data
Nov. 29, 2024 (KR) 10-2024-0175818

(51) Int. Cl. G06T 7/00; G06T 7/60; G06T 7/73

(52) U.S. Cl. CPC G06T 7/001; G06T 7/60; G06T 7/73; G06T 2207/20084; G06T 2207/30144

(57) ABSTRACT

A method and system for predicting a drying behavior of droplets includes acquiring learning data for a reference droplet, performing a learning process on the learning data using a neural network model, acquiring input data for a target droplet and acquiring output data for the input data using the neural network model. The learning data includes a first dataset acquired for the reference droplet according to a time series in a first pressure state and a second dataset acquired for the reference droplet according to a time series in a second pressure state. Each of the first dataset and the second dataset includes information on a pressure applied to the reference droplet, contact angle information of the reference droplet and contact radius information of the reference droplet.

This application claims priority to Korean Patent Application No. 10-2024-0175818, filed on Nov. 29, 2024, and all the benefits accruing therefrom under 35 U.S.C. § 119, the content of which in its entirety is herein incorporated by reference.

### BACKGROUND

### 1. Field

Embodiments relate to methods and systems for predicting the drying behavior of droplets, and more particularly, to methods and systems capable of quickly and accurately predicting the drying behavior of droplets using a learned network model.

### 2. Description of the Related Art

A display manufacturing process or semiconductor manufacturing process may include micro processes in which inkjet printing may be utilized. Inkjet printing, which involves ejecting ink at desired locations, may be widely utilized for creating thin films with patterns.

Inkjet printing is an economical method that may save materials for forming thin films in micro processes such as display manufacturing processes or semiconductor manufacturing processes.

### SUMMARY

When ink used in inkjet printing dries over time after being ejected, dewetting phenomena (e.g., phenomena that the thickness of thin films become uneven) may occur during thin film formation.

To prevent such dewetting phenomena, when heat-sensitive materials such as quantum dots are used, processes using heat for quick drying of ejected droplets are employed, which may cause reliability issues in display devices.

Embodiments include methods and systems for predicting the drying behavior of droplets. The described objective is just an example and does not limit the scope of the disclosure.

Additional features will be set forth in part in the description which follows and, in part, will be apparent from the description, or may be learned by practice of the presented embodiments of the disclosure.

In an embodiment of the disclosure, a method for predicting drying behavior of droplets includes acquiring learning data for a reference droplet, performing a learning process on the learning data using a neural network model, acquiring input data for a target droplet, and acquiring output data for the input data using the neural network model. The learning data includes a first dataset acquired for the reference droplet according to a time series in a first pressure state and a second dataset acquired for the reference droplet according to a time series in a second pressure state, where each of the first dataset and the second dataset includes information on a pressure applied to the reference droplet, contact angle information of the reference droplet, and contact radius information. The input data includes a third dataset acquired at a plurality of points in time for the target droplet in a third pressure state, where the third dataset includes information on a pressure applied to the target droplet, contact angle information of the target droplet, and contact radius information of the target droplet. The output data includes contact angle information and contact radius information of the target droplet at a future point in time in the third pressure state.

In an embodiment, the reference droplet and the target droplet may include or consist of the same material as each other.

In an embodiment, the above neural network model may be a Long Short-Term Memory (“LSTM”).

In an embodiment, the acquiring of the above learning data may include acquiring the information on the pressure applied to the reference droplet, a step of acquiring first images of the reference droplet a plurality of times over time, and acquiring contact angle information and contact radius information of the reference droplet a plurality of times based on the first images.

In an embodiment, the above first images may include first-first images taken of the reference droplet in a reference direction perpendicular to a floor surface on which the reference droplet is placed, and first-second images taken of the reference droplet in a direction intersecting the reference direction.

In an embodiment, the acquiring of the contact angle information and contact radius information of the above-mentioned reference droplet a plurality of times may acquire the contact radius information of the above-mentioned reference droplet from the above-mentioned 1-1 images, and acquire the contact angle information of the above-mentioned reference droplet from the above-mentioned 1-2 images.

In an embodiment, the acquiring of input data for the target droplet may include acquiring the information on the pressure applied to the target droplet, acquiring second images for the target droplet a plurality of times over time, and acquiring contact angle information and contact radius information for the target droplet a plurality of times based on the second images.

In an embodiment, the second images may include second-1st images in which the target droplet is taken in a reference direction perpendicular to the floor surface on which the target droplet is disposed, and second-2nd images in which the target droplet is taken in a direction intersecting the reference direction.

In an embodiment, the contact radius information of the above target droplet may be acquired from the above 2-1 images.

In an embodiment, the contact angle information of the above target droplet may be acquired from the above 2-2 images.

In an embodiment, when the third pressure state is the first pressure state, the output data may be acquired based on the first data set, and when the third pressure state is the second pressure state, the output data may be acquired based on the second data set.

In order to address the above-described features, a system for predicting drying behavior of droplets in an embodiment includes a chamber including a reference droplet or a target droplet therein, a vacuum pump for controlling pressure inside the chamber, a camera device for photographing the inside of the chamber, and a computing device configured to control the vacuum pump and the camera device, acquire learning data for the reference droplet, perform a learning process on the learning data using a neural network model, acquire input data for the target droplet, and acquire output data for the input data using the neural network model. The learning data includes a first dataset acquired for the reference droplet according to a time series in a first pressure state, and a second dataset acquired for the reference droplet according to a time series in a second pressure state, in which each of the first dataset and the second dataset includes information on a pressure applied to the reference droplet, contact angle information of the reference droplet, and contact radius information. The input data includes a third dataset acquired at a plurality of points in time for the target droplet in a third pressure state, and the third dataset includes information on a pressure applied to the target droplet, contact angle information of the target droplet, and contact radius information. The output data includes contact angle information and contact radius information of the target droplet at a future point in time in the third pressure state.

In an embodiment, the reference droplet and the above target droplet may include or consist of the same material as each other.

In an embodiment, the neural network model may be an LSTM.

In an embodiment, the computing device may acquire the information on the pressure applied to the reference droplet, acquire first images of the reference droplet a plurality of times over time, and acquire contact angle information and contact radius information of the reference droplet a plurality of times based on the first images.

In an embodiment, the first images may include first-first images taken of the reference droplet in a reference direction perpendicular to a floor surface on which the reference droplet is placed, and first-second images taken of the reference droplet in a direction intersecting the reference direction.

In an embodiment, the computing device may acquire contact radius information of the reference droplet from the first-first images, and acquire contact angle information of the reference droplet from the first-second images.

In an embodiment, the computing device may acquire the information on the pressure applied to the target droplet, acquire second images of the target droplet a plurality of times over time, and acquire contact angle information and contact radius information of the target droplet a plurality of times based on the second images.

In an embodiment, the second images may include 2-1 images in which the target droplet is taken in a reference direction perpendicular to the floor surface on which the target droplet is placed, and 2-2 images in which the target droplet is taken in a direction intersecting the reference direction.

In an embodiment, the computing device may acquire contact radius information of the target droplet based on the 2-1 images, and may acquire contact angle information of the target droplet based on the 2-2 images.

### BRIEF DESCRIPTION OF THE DRAWINGS

The above and other features and advantages of illustrative embodiments of the disclosure will be more apparent from the following description taken in conjunction with the accompanying drawings, in which:

FIG. 1 is a flowchart schematically illustrating an embodiment of a method for predicting drying behavior of droplets;

FIG. 2 is a flowchart schematically illustrating operations for acquiring learning data for a reference droplet shown in FIG. 1;

FIG. 3 is a flowchart schematically illustrating operations for acquiring input data for a target droplet shown in FIG. 1;

FIG. 4 is a conceptual diagram schematically illustrating an embodiment of a system for predicting drying behavior of droplets;

FIG. 5 is a conceptual diagram schematically illustrating an embodiment of a system for predicting drying behavior of droplets;

FIG. 6 is a conceptual diagram schematically illustrating a computing device illustrated in FIGS. 4 and 5;

FIG. 7 is a conceptual diagram of a neural network model according to the specification;

FIG. 8 is a conceptual diagram illustrating in detail one cell included in the neural network model of FIG. 7;

FIG. 9 is a side view showing a drying behavior of a reference droplet over time;

FIGS. 10 to 13 are graphs showing predicted and actual measured values of contact angles and contact radii for target droplets under each pressure condition; and

FIG. 14 is an embodiment of a time-volume ⅔ power graph with actual conditions applied.

### DETAILED DESCRIPTION

Reference will now be made in detail to embodiments, illustrative embodiments of which are illustrated in the accompanying drawings, where like reference numerals refer to like elements throughout. In this regard, embodiments may have different forms and should not be construed as being limited to the descriptions provided herein. Accordingly, the embodiments are merely described below, by referring to the drawing figures, to explain features of the description. As used herein, the term ‘and/or’ includes any and all combinations of one or more of the associated listed items. Throughout the disclosure, the expression ‘at least one of a, b or c’ indicates only a, only b, only c, both a and b, both a and c, both b and c, all of a, b, and c, or variations thereof.

While embodiments may have various modifications and alternative forms, specific examples thereof are shown by way of example in the drawings and will be described in detail. Effects and features of embodiments and methods for achieving the effects and features will become apparent with reference to the embodiments described below together with the drawings. However, the disclosure is not limited to those disclosed below and may be implemented in various forms.

Hereinafter, embodiments will be described in detail with reference to the accompanying drawings. When describing with reference to the drawings, the same reference numerals are used for the same or corresponding components, and redundant descriptions thereof will be omitted.

In the examples below, the terms first, second, etc. are not used in a limiting sense but are used for the purpose of distinguishing one component from another. Additionally, in the examples below, singular expressions include plural expressions unless the context clearly indicates otherwise.

In the examples below, when various components such as layers, films, regions, and plates are described as being ‘on’ other components, the description may include not only being ‘directly on’ the components but also having other components interposed between the components.

Additionally, for convenience of explanation, sizes of components in the drawings may be exaggerated or reduced. For example, sizes and thicknesses of each component shown in the drawings are arbitrarily shown for convenience of explanation, and thus embodiments are not necessarily limited to what is illustrated.

In the examples below, terms such as ‘include’ or ‘have’ mean that features or components described in the specification are present, and do not exclude in advance the possibility that one or more other features or components may be added.

In the examples below, when portions such as films, regions, components, etc. are described as being on or above another portion, the description includes not only cases where portions are directly above other portions, but also cases where other films, regions, components, etc. are interposed between portions.

In some embodiments, where the implementation is otherwise feasible, specific process sequences may be performed in a different order than described. For example, two processes described sequentially may be performed substantially simultaneously, or may proceed in the reverse order from that described.

Throughout the specification, ‘A and/or B’ refers to either A, B, or both A and B. Moreover, ‘at least one of A and B’ indicates A, B, or both A and B.

In the following examples, when it is said that a film, region, component, etc. are connected, it includes a case where the films, regions, or components are directly connected, and/or a case where other films, regions, or components are interposed between the films, regions, or components and are indirectly connected. For example, when it is said in the specification that a film, region, component, etc., are electrically connected, it refers to a case where the film, region, component, etc., are directly electrically connected, and/or a case where another film, region, component, etc. is interposed between them and is indirectly electrically connected.

In the examples below, the x-axis, y-axis, and z-axis are not limited to three axes on an orthogonal coordinate system, and may be interpreted in a broad sense that includes them. For example, the x-axis, y-axis, and z-axis may be orthogonal to each other, but may also refer to different directions that are not orthogonal to each other.

The terms such as “device” as used herein are intended to mean a hardware component such as a circuitry that performs a predetermined function. The hardware component may include a field-programmable gate array (“FPGA”) or an application-specific integrated circuit (“ASIC”), for example.

Hereinafter, a method and system for predicting the drying behavior of a droplet in an embodiment will be described in detail based on the above description.

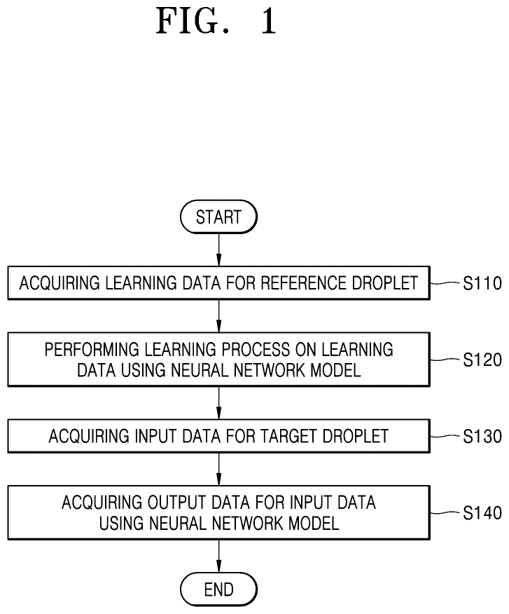

FIG. 1 is a flowchart schematically illustrating an embodiment of a method for predicting drying behavior of droplets.

Referring to FIG. 1, the method for predicting the drying behavior of droplets in an embodiment may include acquiring learning data for a reference droplet (S110).

A reference droplet may refer to a droplet for acquiring learning data. The reference droplet may include or consist of the same material as a target droplet to be measured. In an embodiment, the reference droplet and the target droplet may include or consist of the same material and may have the same volume within a margin of error, for example.

The learning data may refer to data representing characteristics of drying behavior of the reference droplet. The learning data may be big data for training a neural network model, which will be described below.

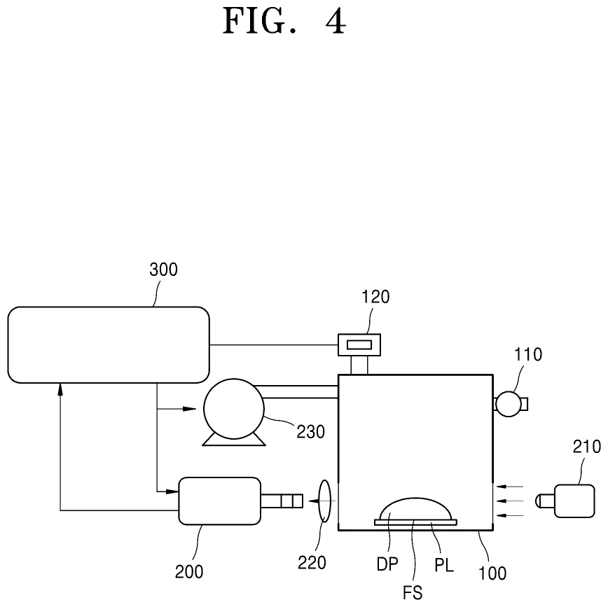

The learning data may include datasets acquired according to time series under various pressure conditions. The learning data may include a first dataset acquired for the reference droplet according to a time series in a first pressure state. The first dataset may include contact angle information and contact radius information of the reference droplet acquired in the first pressure state. The first dataset may further include information on pressure applied to the reference droplet in the first pressure state (or information on internal pressure of a chamber 100 (shown in FIG. 4), first pressure information).

In an embodiment, images may be acquired at predetermined points in time in the chamber 100 (shown in FIG. 4) under the first pressure state, for example. When an image of the reference droplet is acquired at a first-1st time-point, contact angle information and contact radius information of the reference droplet may be acquired from the image at the first-1st time-point using vision recognition technology. In an embodiment, a first-2nd time-point may be a point in time after a predetermined period from the first-1st time-point, for example. When an image of the reference droplet is acquired at the first-2nd time-point, contact angle information and contact radius information of the reference droplet may be acquired from the image at the first-2nd time-point using vision recognition technology. In an embodiment, a first-3rd time-point may be a point in time after a predetermined period from the first-2nd time-point. When an image of the reference droplet is acquired at the first-3rd time-point, contact angle information and contact radius information of the reference droplet may be acquired from the image at the first-3rd time-point using vision recognition technology, for example. Additionally, contact angle information and contact radius information of the reference droplet may be acquired using images of the reference droplet acquired at points in time subsequent to the first-3rd time-point. Contact angle information and contact radius information acquired for the reference droplet may be included in the learning data.

The learning data may include a second dataset acquired for the reference droplet according to a time series in a second pressure state. The second dataset may include contact angle information and contact radius information of the reference droplet acquired in the second pressure state. The second dataset may further include information on pressure applied to the reference droplet in the second pressure state (or information on internal pressure of the chamber 100 (shown in FIG. 4), second pressure information).

In an embodiment, images may be acquired at predetermined points in time in the chamber 100 (shown in FIG. 4) under the second pressure state, for example. When an image of the reference droplet is acquired at a second-1st time-point, contact angle information and contact radius information of the reference droplet may be acquired from the image at the second-1st time-point using vision recognition technology. In an embodiment, a second-2nd time-point may be a point in time after a predetermined period from the second-2nd time-point, for example. When an image of the reference droplet is acquired at the second-2nd time-point, contact angle information and contact radius information of the reference droplet may be acquired from the image at the second-2nd time-point using vision recognition technology. In an embodiment, a second-3rd time-point may be a point in time after a predetermined period from the second-2nd time-point, for example. When an image of the reference droplet is acquired at the second-3rd time-point, contact angle information and contact radius information of the reference droplet may be acquired from the image at the second-3rd time-point using vision recognition technology. Additionally, contact angle information and contact radius information of the reference droplet may be acquired using images of the reference droplet acquired at points in time subsequent to the second-3rd time-point. The acquired contact angle information and the contact radius information of the reference droplet may be included in the learning data.

Among the learning data, the contact angle information and the contact radius information of the reference droplet are acquired according to a time series (e.g., over time) in the first pressure state or the second pressure state, in which the contact angle information and the contact radius information of the reference droplet may be acquired using a vision recognition technology.

In an embodiment, when images of the reference droplet are acquired over time, feature points of the reference droplet may be extracted from the images, and the contact angle information and the contact radius information of the reference droplet may be acquired based on the extracted feature points, for example. In an embodiment, when a boundary of a droplet is extracted through image processing, a coordinate of a contact line of the droplet are acquired from the boundary, and the contact angle and the contact radius may be extracted through the coordinates of the contact line, for example. The coordinate of the contact line may refer to a plurality of coordinate values representing the boundary of the droplet.

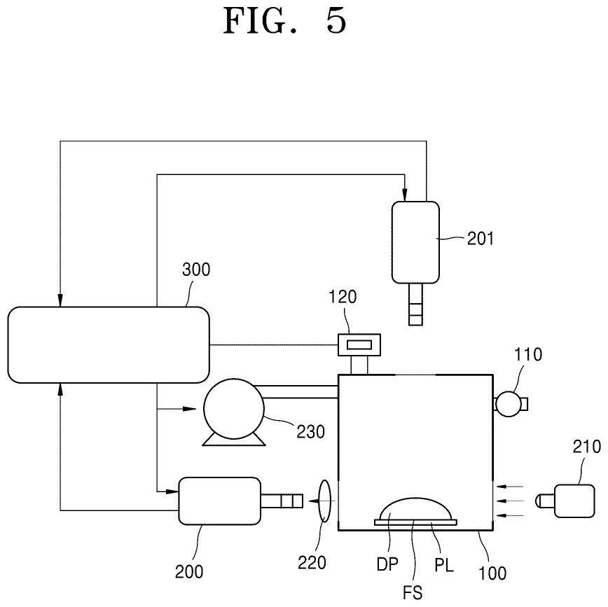

To acquire the contact angle information and the contact radius information of the reference droplet, the reference droplet needs to be taken from two directions. In an embodiment, the images generated by photographing the reference droplet in a direction (also referred to as a reference direction) may be used to acquire the contact radius information, and the direction is perpendicular to a plate (e.g., PL in FIGS. 4 and 5) or floor surface (e.g., FS in FIGS. 4 and 5) on which the reference droplet is disposed, for example. In an embodiment, the images generated by photographing the reference droplet in a direction may be used to acquire contact angle information, and the direction is parallel to the direction in which the plate (e.g., PL in FIGS. 4 and 5) or the floor surface (e.g., FS in FIGS. 4 and 5) on which the reference droplet is disposed extends, for example.

In an embodiment, the method for predicting drying behavior of droplets may include performing a learning process on the learning data using a neural network model (S120). In an embodiment, the neural network model may be a Recurrent Neural Network (“RNN”) model, for example. In an embodiment, the neural network model may be a Long Short-Term Memory (“LSTM”), for example. In an embodiment, to learn correlations over time in the learning data, the neural network model may be an LSTM among RNN models, for example.

In an embodiment, the method for predicting drying behavior of the droplets may include acquiring input data for the target droplet (S130).

The target droplet may be an object whose drying behavior is to be predicted using the learned neural network model. The target droplet may include or consist of the same material as that of the reference droplet and may have the same volume within a margin of error.

The input data may include a third dataset acquired at a plurality of points in time for the target droplet in a third pressure state. In an embodiment, the third dataset may include information on pressure applied to the target droplet (or information on internal pressure of the chamber 100 (shown in FIG. 4), third pressure information), contact angle information of the target droplet, and contact radius information of the target droplet, for example.

In an embodiment, the method for predicting drying behavior of droplets may include acquiring output data for the input data using the neural network model (S140). In an embodiment, the neural network model may be an LSTM, for example.

The output data refers to result values output from the neural network model, and input values input into the neural network model may be the input data described above. In an embodiment, the output data may include predicted values for the contact angle information and/or the contact radius information of the target droplet at a preset future point in time, for example. In an embodiment, the output data may include the contact angle information and/or the contact radius information that the target droplet may have at a future point in time under pressure conditions within the chamber 100 (shown in FIG. 4). In an embodiment, the future point in time may refer to a point in time after a computing device or a processor, described below, performs calculations desired for the embodiments, for example.

In an embodiment, the third pressure state may be the first pressure state or the second pressure state, for example. In an embodiment, when the third pressure state is one of the pressure states included in the learning data, the output data may be output from the neural network model based on a dataset acquired in a pressure state identical to the third pressure state, for example. In an embodiment, when the third pressure state is the first pressure state, the output data may be acquired based on the first dataset, for example. In an embodiment, when the third pressure state is the second pressure state, the output data may be acquired based on the second dataset, for example. Additionally, the third pressure state may be another pressure state included in the learning data, and when the third pressure state is another pressure state included in the learning data, the output data may be acquired using a dataset acquired from another pressure state included in the learning data.

In an embodiment, the third pressure state may not be the first pressure state or the second pressure state, for example. In an embodiment, the third pressure state may not be identical to any of the pressure states included in the learning data, for example. In this case, acquiring output data for the input data may include extracting a proximity dataset acquired in a pressure state closest to the third pressure state among the learning data, and acquiring output data for the input data based on the extracted proximity dataset.

The extracting of the proximity dataset acquired in the pressure state closest to the third pressure state among the learning data may be extracting a proximity dataset acquired in a pressure state within a predetermined range of the third pressure state among the learning data. In an embodiment, among the pressure information included in the learning data, a third pressure state and pressure information within a predetermined range may be selected, and a nearby data set acquired in a pressure state corresponding to the selected pressure information may be extracted, for example.

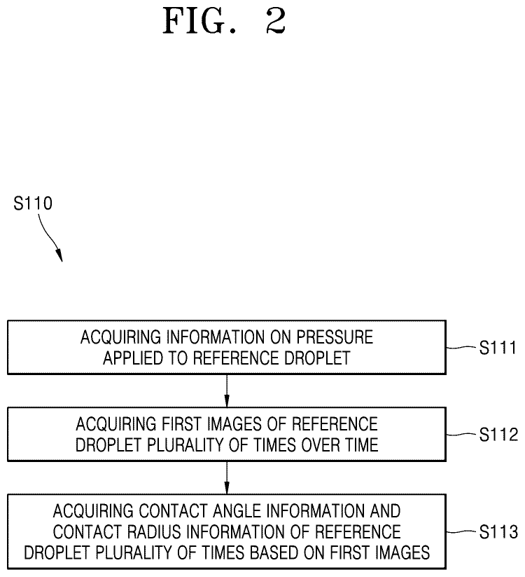

FIG. 2 is a flowchart schematically illustrating operations for acquiring learning data for the reference droplet of FIG. 1.

Referring to FIG. 2, the acquiring of the learning data for the reference droplet (S110) may include acquiring information on a pressure applied to the reference droplet (S111).

The information on the pressure applied to the reference droplet may be internal pressure information of the chamber 100 (shown in FIG. 4) in which the reference droplet is disposed. The internal pressure information of the chamber 100 (shown in FIG. 4) may be generated by a pressure sensor disposed in the chamber 100 (shown in FIG. 4). The acquiring of the information on the pressure applied to the reference droplet (S111) may be an acquiring internal pressure information of the chamber 100 (shown in FIG. 4) from the pressure sensor disposed in the chamber 100 (shown in FIG. 4).

Acquiring learning data for the reference droplet (S110) may further include acquiring first images of the reference droplet a plurality of times over time (S112).

The first images may be images of the reference droplet taken at regular time intervals. The first images may be images of the reference droplet inside the chamber 100 (shown in FIG. 4) at a predetermined pressure, and the first images may be images capturing the drying behavior of the reference droplet as the reference droplet dries over time.

Acquiring learning data for the reference droplet (S110) may further include acquiring the contact angle information and the contact radius information of the reference droplet a plurality of times based on the first images (S113).

The first images may include first-1st images and first-2nd images. The first-1st images may be images of the reference droplet taken in a direction perpendicular to the floor surface (e.g., FS in FIGS. 4 and 5) on which the reference droplet is disposed. The first-2nd images may be images of the reference droplet taken in a direction intersecting the reference direction. In an embodiment, the first-1st images may be plan view images of the reference droplet taken from above the reference droplet, and the first-2nd images may be front view, back view, or side view images of the reference droplet taken from the front, back, or side of the reference droplet, for example. The first-2nd images may be images of the reference droplet taken from a direction parallel to the floor surface (e.g., FS in FIGS. 4 and 5) on which the reference droplet is disposed.

Acquiring contact angle information and contact radius information of the reference droplet a plurality of times based on the first images (S113) may include acquiring contact radius information a plurality of times based on the first-1st images and acquiring contact angle information a plurality of times based on the first-2nd images. The first-1st images may be images from which contact radius information may be most accurately acquired, and the first-1st images are taken of the reference droplet in the vertical direction. The first-2nd images may be images from which contact angle information may be most accurately acquired, and the first-2nd images are taken of the reference droplet in the horizontal direction.

The contact angle information and contact radius information may be acquired by applying vision recognition technology to the first images. The contact angle information may be angle information between the boundary (or border) of the reference droplet identified in each of the first images (or first-2nd images) and the floor surface (e.g., FS in FIGS. 4 and 5) identified in each of the first images (or first-2nd images). The contact radius information may be radius information derived from the boundary (or border) of the reference droplet identified in each of the first images (or first-1st images).

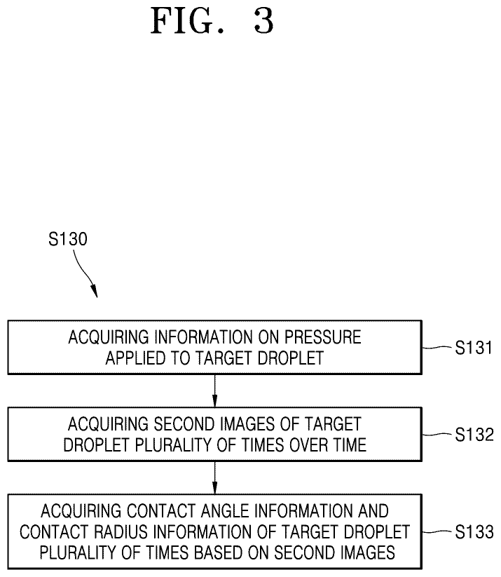

FIG. 3 is a flowchart schematically illustrating operations for acquiring input data for the target droplet of FIG. 1.

Referring to FIG. 3, acquiring input data for the target droplet (S130) may include acquiring information on a pressure applied to the target droplet (S131).

The information on the pressure applied to the target droplet may be internal pressure information of the chamber 100 (shown in FIG. 4) in which the target droplet is disposed. The internal pressure information of the chamber 100 (shown in FIG. 4) may be generated by a pressure sensor disposed in the chamber 100 (shown in FIG. 4). The acquiring of the pressure information for the target droplet (S131) may include acquiring internal pressure information of the chamber 100 (shown in FIG. 4) from a pressure sensor disposed in the chamber 100 (shown in FIG. 4).

The acquiring of the input data for the target droplet (S130) may further include acquiring second images of the target droplet a plurality of times over time (S132).

The second images may be images of the target droplet taken at regular time intervals. The second images may be images of the target droplet inside the chamber 100 (shown in FIG. 4) at a predetermined pressure, and the second images may be images capturing the drying behavior of the target droplet as the target droplet dries over time.

Acquiring input data for the target droplet (S130) may further include acquiring contact angle information and contact radius information of the target droplet a plurality of times based on the second images (S133).

The second images may include second-1st images and second-2nd images. The second-1st images may be images of the target droplet taken in a direction perpendicular to the floor surface (e.g., FS in FIGS. 4 and 5) on which the target droplet is disposed. The second-2nd images may be images of the target droplet taken in a direction intersecting the reference direction. In an embodiment, the second-1st images may be plan view images of the target droplet taken from above the target droplet, and the second-2nd images may be front view, back view, or side view images of the target droplet taken from the front, back, or side of the target droplet, for example. The second-2nd images may be images of the target droplet taken from a direction parallel to the floor surface (e.g., FS in FIGS. 4 and 5) on which the target droplet is disposed.

Acquiring contact angle information and contact radius information of the target droplet a plurality of times based on the second images (S133) may include acquiring the contact radius information a plurality of times based on the second-1st images and acquiring the contact angle information a plurality of times based on the second-2nd images. The second-1st images may be images from which the contact radius information may be most accurately acquired, and the second-1st images are taken of the target droplet in the vertical direction. The second-2nd images may be images from which contact angle information may be most accurately acquired, and the second-2nd images are taken of the target droplet in the horizontal direction.

The contact angle information and contact radius information may be acquired by applying vision recognition technology to the second images. The contact angle information may be angle information between the boundary (or border) of the target droplet identified in each of the second images (or second-2nd images) and the floor surface (e.g., FS in FIGS. 4 and 5) identified in each of the second images (or second-2nd images). The contact radius information may be radius information derived from the boundary (or border) of the target droplet identified in each of the second images (or second-1st images).

FIG. 4 is a conceptual diagram schematically illustrating an embodiment of a system for predicting drying behavior of droplets.

As illustrated in FIG. 4, the system for predicting drying behavior of droplets in an embodiment may include the chamber 100, a vacuum pump 230, a camera device 200, and a computing device 300.

The chamber 100 may refer to a sealed container designed to create and maintain a pressure state lower than atmospheric pressure. A plate PL on which a droplet DP or a substrate with a printed droplet DP may be disposed may be disposed inside the chamber 100. The droplet DP in the specification may refer to the reference droplet or target droplet described above. Accordingly, the reference droplet or the target droplet described above may be disposed on the plate PL.

The vacuum pump 230 may refer to a device capable of controlling pressure inside the chamber 100. The vacuum pump 230 may be operated by control signals from the computing device 300. The vacuum pump 230 may exhaust air from inside the chamber 100 to outside the chamber 100.

The camera device 200 may be disposed to face the interior of the chamber 100, and may be a device for photographing the droplet DP disposed inside the chamber 100. The camera device 200 may be a device that generates images by photographing the droplet DP. Image data generated from the camera device 200 may be transmitted to the computing device 300. In an embodiment, the camera device 200 may include an optical camera, an infrared camera, and an ultraviolet camera, for example.

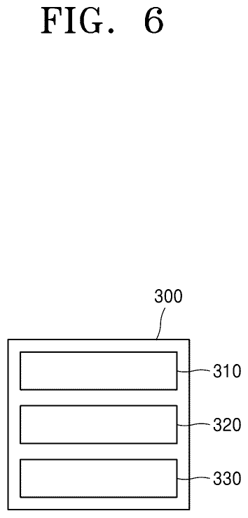

The computing device 300 may extract or acquire desired information based on image data acquired from the camera device 200. Operations desired in the computing device 300 may be performed by a processor 310 to be described below with reference to FIG. 6, and operations performed by the processor 310 may be based on instructions stored in a memory 320 to be described below with reference to FIG. 6.

In an embodiment, the computing device 300 may control components of the system for predicting drying behavior of droplets, including the vacuum pump 230 and the camera device 200, for example. In an alternative embodiment, the computing device 300 may generate control commands for controlling components of the system for predicting drying behavior of the droplets, including the vacuum pump 230 and the camera device 200, and the components may operate based on the control commands.

The computing device 300 may acquire the learning data for the reference droplet and perform a learning process on the learning data using a neural network model. As described above, the learning data may include datasets acquired according to time series under various pressure states. Further description of the learning data characteristics is omitted due to redundancy with the previous description.

The computing device 300 may acquire the input data for the target droplet and acquire the output data for the input data using the neural network model. As described above, the input data may include datasets acquired over time under a predetermined pressure state, and the description of the input data characteristics is omitted due to redundancy with the previous description.

The neural network model used by the computing device 300 to acquire the output data may be the neural network model used to acquire the learning data for the reference droplet. The neural network model used by the computing device 300 to acquire the output data and learning data may be an LSTM. Further description of the neural network model characteristics is omitted due to redundancy with the previous description.

As illustrated in FIG. 4, the system for predicting drying behavior of droplets in embodiments may further include a pressure valve 110 configured to control pressure inside the chamber 100. The system may further include a pressure gauge 120 configured to indicate pressure inside the chamber 100.

The pressure valve 110 may include pipes for discharging gas from inside the chamber 100 to the exterior or injecting gas from the exterior into the chamber 100, and a valve for controlling opening and closing of the pipes. When the pressure valve 110 is turned on, gas inside and outside the chamber 100 may be circulated, and when the pressure valve 110 is turned off, the inside and outside of the chamber 100 may be blocked.

The pressure gauge 120 displays the pressure state inside chamber 100 formed by the vacuum pump 230. The pressure gauge 120 receives and displays pressure information from a pressure sensor (not shown) installed inside chamber 100, or displays pressure information received from computing device 300, and computing device 300 may receive preset pressure information from vacuum pump 230.

As illustrated in FIG. 4, the system for predicting drying behavior of droplets in an embodiment may further include a light source 210 configured to irradiate light onto a reference droplet or a target droplet.

The light source 210 may irradiate light into the interior of the chamber 100. Based on an optical path, the chamber 100 including or consisting of a reference droplet or a target droplet inside may be disposed between the light source 210 and the camera device 200, for example. The light source 210 may irradiate light into the interior through a transparent window formed in the chamber 100. Light irradiated into the chamber 100 may pass through the reference droplet or the target droplet, may be refracted by the reference droplet or the target droplet, or may be reflected by the reference droplet or the target droplet.

The light inside the chamber 100 may be directed toward a lens 220 disposed outside the chamber 100. In an embodiment, the lens 220 may be disposed between the chamber 100 and the camera device 200, for example. In an embodiment, the lens 220 may be a convex lens configured to magnify and observe the reference droplet or target droplet inside the chamber 100, for example. The camera device 200 may generate image data of the reference droplet or target droplet inside the chamber 100 through the lens 220.

In an embodiment, to generate image data of a side view of the reference droplet or target droplet, the camera device 200 may be disposed at the same height as the reference droplet or target droplet with respect to the floor surface FS, for example. As a result, the camera device 200 may generate the image data for a side view of the reference droplet or the target droplet.

FIG. 5 is a conceptual diagram schematically illustrating an embodiment of a system for predicting drying behavior of droplets.

As illustrated in FIG. 5, the system for predicting drying behavior of droplets In an embodiment may further include a second camera device 201. The second camera device 201 may photograph a plane view of the reference droplet or target droplet from outside the chamber 100. In an embodiment, the second camera device 201 may be disposed facing downward in a direction perpendicular to the plate PL on which the reference droplet or the target droplet is disposed, for example.

The computing device 300 may receive the first-2nd images of a side view of the reference droplet or the target droplet from the camera device 200 and the first-1st images of a plane view of the reference droplet or the target droplet from the second camera device 201. The computing device 300 may acquire the contact radius information of the reference droplet or the target droplet from the first-1st images of the side view, and acquire the contact angle information of the reference droplet or the target droplet from the first-2nd images of the side view.

FIG. 6 is a conceptual diagram schematically illustrating the computing device illustrated in FIGS. 4 and 5.

As illustrated in FIG. 6, the computing device 300 may include a processor 310, a memory 320, and a data transceiver 330. Additionally, the computing device 300 may receive user input from a user and perform preset commands or operation tasks based on the received user input.

The processor 310 may control other components included in the computing device 300 by executing instructions stored in the memory 320. The processor 310 may execute instructions stored in the memory 320.

The processor 310 is a configuration capable of performing operations and controlling other devices. Primarily, the processor may refer to microprocessors, central processing units, application processors, and graphics processing units.

The processor 310 may process signals, data, and information input or output through the components discussed above, or may operate application programs stored in the memory 320 to provide or process appropriate information or functions for users.

The memory 320 stores data supporting various functions of the computing device 300. The memory 320 may store a plurality of application programs (applications), data and instructions for operation of the computing device 300, and data and instructions for training the neural network model.

The memory 320 may include at least one type of storage medium among flash memory type, hard disk type, Solid State Disk (“SSD”) type, Silicon Disk Drive (“SDD”) type, multimedia card micro type, card type memory (e.g., Secure Digital (“SD”) or extreme Digital (“XD”) memory), Random Access Memory (“RAM”), Static Random Access Memory (“SRAM”), Read-Only Memory (“ROM”), Electrically Erasable Programmable Read-Only Memory (“EEPROM”), Programmable Read-Only Memory (“PROM”), magnetic memory, magnetic disk, and optical disk.

The data transceiver 330 may perform wired communication and/or wireless communication functions for transmitting and receiving data between components. The data transceiver 330 may include a data transmission/reception interface configured to perform wired communication and/or wireless communication functions.

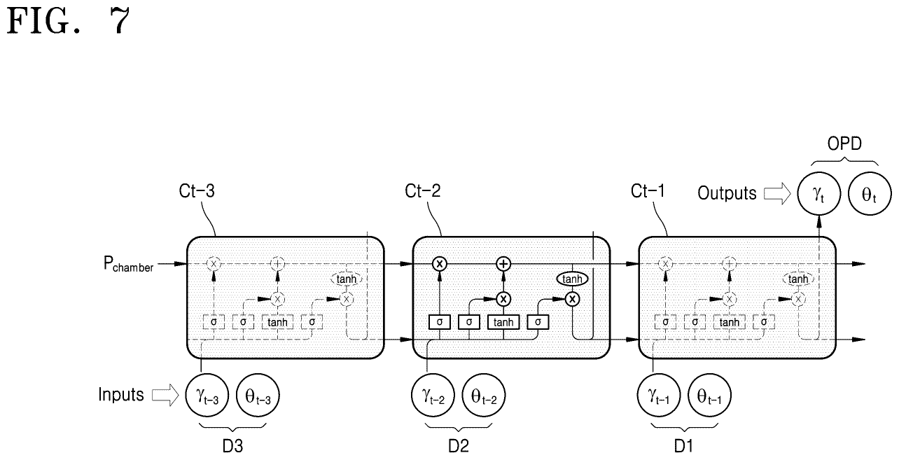

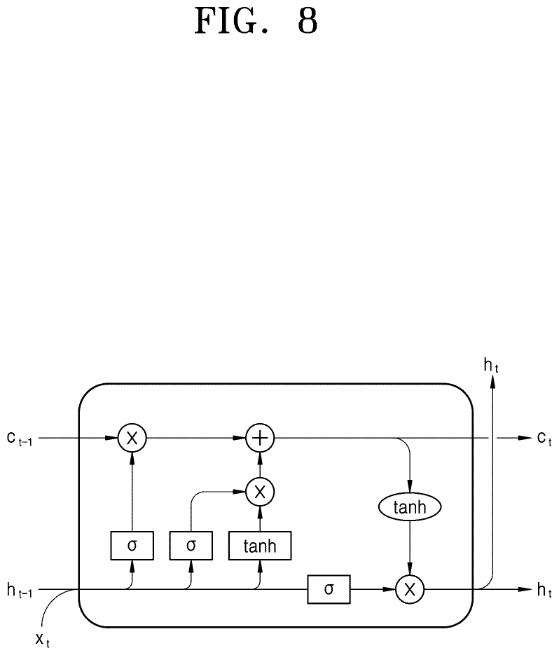

FIG. 7 is a conceptual diagram of a neural network model described in the specification, and FIG. 8 is a conceptual diagram illustrating in detail one cell included in the neural network model of FIG. 7.

As illustrated in FIG. 7, the neural network model described in the specification may be the LSTM. The input values to the LSTM may include the contact angle information and the contact radius information of the target droplet at three points in time.

The input values input to the LSTM may be the input data described above (the contact angle information and the contact radius information of the target droplet). In an embodiment, the first input value D1 input to the LSTM may be contact angle information θₜ₋₁ and contact radius information rₜ₋₁ of the reference droplet at the first time point t-1, for example. In an embodiment, the second input value D2 input to the LSTM may be contact angle information θₜ₋₂ and contact radius information rₜ₋₂ of the reference droplet at the second time point t-2, for example. In an embodiment, the third input value D3 input to the LSTM may be contact angle information et-3 and contact radius information rₜ₋₃ of the reference droplet at the third time point t-3, for example. The first time point t-1 to the third time point t-3 may be different time points, and the second time point t-2 may be a time point before the first time point t-1, and the third time point t-3 may be a time point before the second time point t-2.

When three input data values are input to the LSTM, the computing device 300 may acquire the output data using the LSTM that has previously learned the training data. The output data may include the contact angle information and the contact radius information (predicted values for future points in time) of the target droplet at a future point in time, acquired based on the contact angle information and contact radius information of the target droplet at three points in time.

In an embodiment, an LSTM may include at least three cells, for example. A first input value D1 may be input into the first cell Ct-1, a second input value D2 may be input into the second cell Ct-2, and a third input value D3 may be input into the third cell Ct-3. For convenience of explanation, parameters are shown in the second cell of FIG. 7, however, the first cell Ct-1 and the third cell Ct-3 may also include parameters of the same type.

In an embodiment, the first cell Ct-1 may output an output value (or predicted value OPD) for a predetermined time point t based on the first input value D1 of the first time point t-1, output value generated from the second cell Ct-2, and previously learned data, for example. In an embodiment, the second cell Ct-2 may output an output value (or predicted value OPD) for the first time point t-1 based on the second input value Ct-2 of the second time point t-2, output value generated from the third cell Ct-3, and previously learned data, for example. In an embodiment, the third cell Ct-3 may output an output value (predicted value) for the second time point t-2 based on the input value of the third time point t-3 and previously learned data, for example.

As illustrated in FIG. 8, one cell included in LSTM may include the following gate structures. For convenience of explanation, the cell illustrated in FIG. 8 may be understood as the first cell illustrated in FIG. 7, and the description of the first cell may also apply to the second and third cells described above.

$$\begin{matrix}[ Formula 1 ] & \\ f = sigmoid ( {W}_{f} \cdot [ {h}_{t - 1} , {x}_{t} ] + {b}_{f} ) & \end{matrix}$$

In Formula 1, f is derived by a sigmoid function of a forget gate, W_{f} is a weight matrix of the forget gate, hₜ₋₁ is a hidden state vector at time t-1 (previous time point), xₜ is an input vector at time t (current time point), and bᵣ may be a bias vector of the forget gate. [hₜ₋₁, xₜ] may refer to a concatenation of a previous hidden state and the current input. The forget gate may determine which information from the previous cell state to discard.

$$\begin{matrix}[ Formula 2 ] & \\ i = sigmoid ( {W}_{i} \cdot [ {h}_{t - 1} , {x}_{t} ] + {b}_{i} ) & \end{matrix}$$

In Formula 2, i is derived by the sigmoid function of an input gate, Wᵢ is a weight matrix of the input gate, hₜ₋₁ is the hidden state vector at time t-1 (previous time point), xₜ is an input vector at time t (current time point), and bi may be a bias vector of the input gate. [hₜ₋₁, xₜ] may refer to the concatenation of the previous hidden state and the current input. The input gate may determine which new information to store in the cell state.

$$\begin{matrix}[ Formula 3 ] & \\ C = tanh ( {W}_{C} \cdot [ {h}_{t - 1} , {x}_{t} ] + {b}_{C} ) & \end{matrix}$$

In Formula 3, C is derived by a hyperbolic tangent activation function of a candidate cell state, W_{c} is a weight matrix of the candidate cell state, hₜ₋₁ is the hidden state vector at time t-1 (previous time point), xₜ is a input vector at time t (current time point), and b_{c} may be a bias vector of the candidate cell state. [hₜ₋₁, xₜ] may refer to the concatenation of the previous hidden state and the current input. The candidate cell state may propose new information that may be added to the cell at the current time stage, and may complement or update the previous cell state.

$$\begin{matrix}[ Formula 4 ] & \\ o = sigmoid ( {W}_{o} \cdot [ {h}_{t - 1} , {x}_{t} ] + {b}_{o} ) & \end{matrix}$$

In Formula 4, o is derived by a sigmoid function at the output gate, Wₒ is a weight matrix of the output gate, hₜ₋₁ is the hidden state vector at time t-1 (previous time point), xₜ is an input vector at time t (current time point), and bₒ may be a bias vector of the output gate. [hₜ₋₁, xₜ] may refer to the concatenation of the previous hidden state and the current input. The output gate may determine which portion of the updated cell state to output externally, and may selectively output only appropriate information at each time point when processing sequence data.

The neural network model described in the specification (e.g., LSTM) may train learning data to minimize the error between predicted values and actual values through a loss function that additionally considers physical laws. The loss function may be derived based on Mathematical Formulas 5 to 8 below. In an embodiment, the loss function may be applied to output values output from the output gate, for example.

$$\begin{matrix}[ Formula 5 ] & \\ {L}_{total} = {L}_{NN} + {L}_{P} & \end{matrix}$$

In Formula 5, Lₜₒₜₐₗ is a total loss function, L_{NN} is a loss function for minimizing an error between the prediction of the neural network model and the actual measured value, and L_{P} may be a loss function for measuring how well the prediction of the neural network model follows a physical formula. Lₜₒₜₐₗ is calculated based on a value of the output gate in the LSTM model, and learning proceeds by applying differentiation to the value of the output gate to minimize an error between predicted and actual measured values through a backpropagation process.

$$\begin{matrix}[ Formula 6 ] & \\ {L}_{NN} = {( {r}_{t , a} - {r}_{t , p} )}^{2} + {( {θ}_{t , a} - {θ}_{t , p} )}^{2} & \end{matrix}$$

In Formula 6, r_{t,a} is the actual contact radius, ftp is the predicted contact radius, θ_{t,a} is the actual contact angle, and θ_{t,p} is the predicted contact angle. L_{NN} may guide learning to minimize the error between actual and predicted contact radii and the error between actual and predicted contact angles. Through the learning process of minimizing L_{NN}, L_{NN} may update the weight matrices and bias vectors of Formulas 1 to 4 described above.

$$\begin{matrix}[ Formula 7 ] & \\ {L}_{p} = {( \frac{dV}{dt} - \frac{{V}_{t - 1} - {V}_{t}}{Δ t} )}^{2} & \end{matrix}$$

In Formula 7, Vₜ₋₁ is the volume at the previous point in time, Vₜ is the predicted volume at the next point in time, and dV/dt may refer to the theoretically calculated evaporation rate. Δt may refer to the time difference between the previous time point and the next time point. Lₚ is a device that ensures that the values predicted by the model follow physical laws. Lₚ functions to make the difference between the predicted next point volume and the previous point volume divided by the time difference equal to the theoretical evaporation rate. dV/dt in Mathematical Formula 7 may be calculated by Formula 8.

$$\begin{matrix}[ Formula 8 ] & \\ - \frac{dV}{dt} = α \frac{π {r}_{t - 1} Dc}{ρ} f ( {ϑ}_{t - 1} ) & \end{matrix}$$

Formula 8 may refer to the theoretical evaporation rate. In Formula 8, rₜ₋₁ is the contact radius at the previous time point, Dcₛ is the diffusion coefficient of the solution, a is the pressure coefficient, p is the density of the solution, θₜ₋₁ is the contact angle at the previous time point, and f(θₜ₋₁) may be a morphological coefficient that is a function of the contact angle. The morphological coefficient may be expressed differently depending on the drying behavior.

The LSTM model in an embodiment may effectively learn long-term dependencies of time series data, and may accurately capture complex temporal patterns appearing during the drying process of droplets. In particular, nonlinear changes in drying behavior that were difficult to predict using conventional simple mathematical modeling may be effectively predicted. Additionally, due to the use of a loss function reflecting physical laws proposed herein, predictions that accurately reflect actual physical phenomena may be achieved beyond simple data fitting. The prediction accuracy may be improved by up to 30% compared to existing machine learning methods.

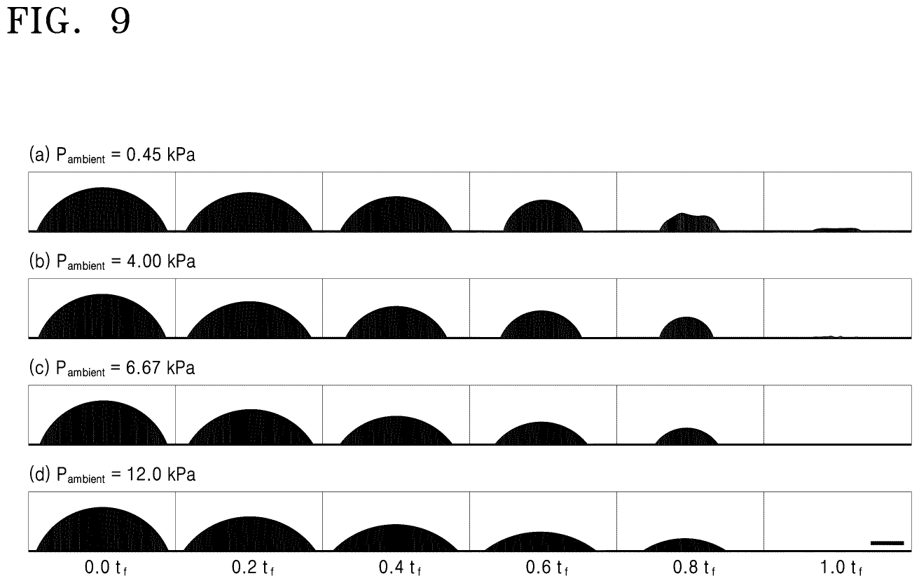

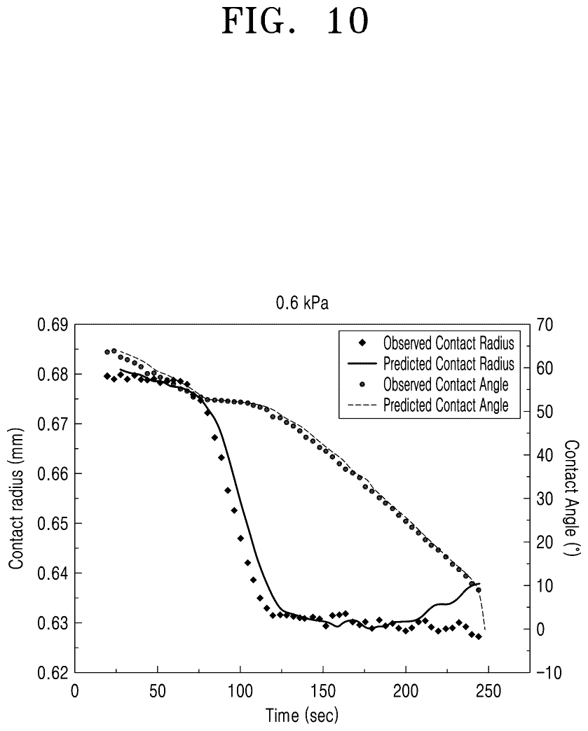

FIG. 9 is a side view showing the drying behavior of a reference droplet over time, and FIGS. 10 to 13 are graphs showing predicted and actually measured values of the predicted contact angle and contact radius for a target droplet under each pressure condition.

As illustrated in FIG. 9, it is confirmed that the volume of the reference droplet decreases as it dries as time passes from 0.0 tf to 1.0 tf, and all other conditions other than the pressure state inside chamber 100 are the same. In an embodiment, the drying behavior of the reference droplet may vary depending on the pressure value (e.g., 0.45 kilopascal (kPa) for the side view (a) of FIG. 9, 4.00 kPa for the side view (b) of FIG. 9, 6.67 kPa for the side view (c) of FIG. 9, and 12.00 kPa for the side view (d) of FIG. 9) inside chamber 100, and the effect of the neural network model mentioned herein May be to learn this behavior of the reference droplet and predict the drying behavior of the target droplet based on the learned data, for example.

Image data acquired for a reference droplet according to a predetermined cycle may include the drying behavior of the reference droplet. The drying behavior acquired from the image data may vary depending on the pressure state inside chamber 100, and information on the pressure state may also be learned when learning the drying behavior.

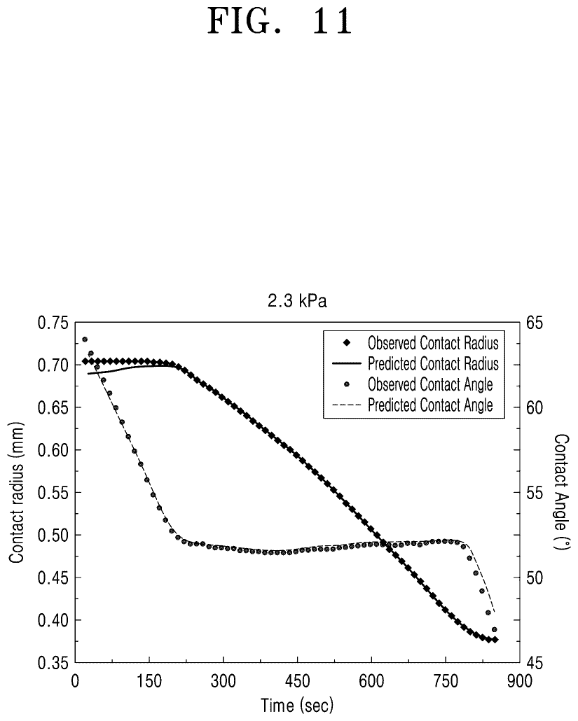

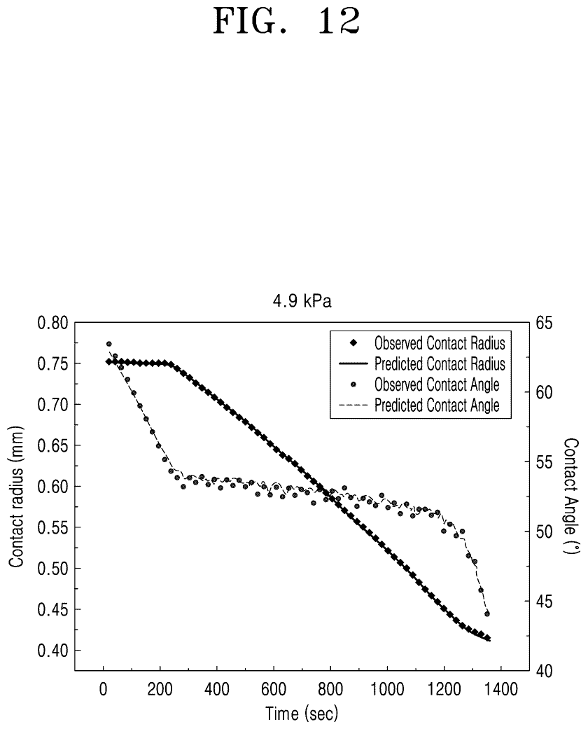

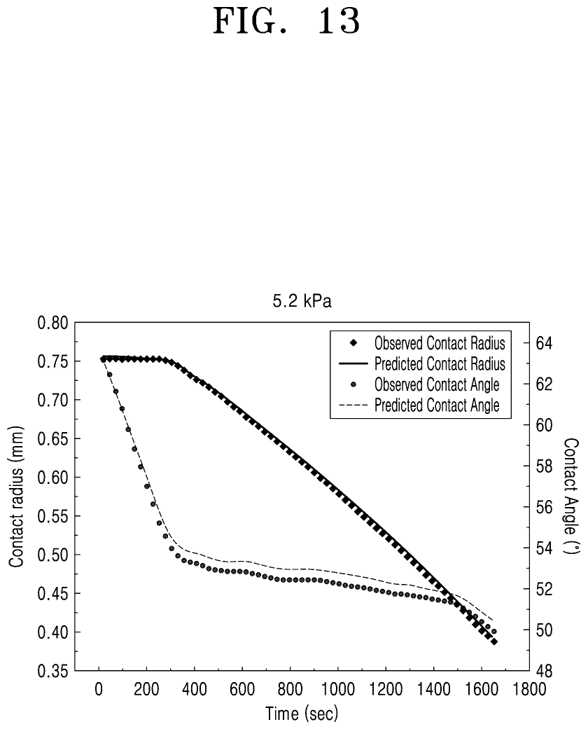

As shown in FIGS. 10 to 13, the predicted and actual measured values of the predicted contact angle and contact radius (in terms of millimeter (mm)) for the target droplet under each pressure condition (e.g., 0.6 kPa for FIG. 10, 2.3 kPa for FIG. 11, 4.9 kPa for FIG. 12, and 5.2 kPa for FIG. 13) are confirmed. The output values from the neural network model (e.g., LSTM) mentioned herein confirm that the predicted contact radius and the actually measured contact radius for the target droplet are almost similar.

The prediction system in an embodiment may predict the drying behavior of droplets in real time, thereby enabling immediate detection and response to problems that may occur during the process. The real-time prediction capability may be a key element in implementing smart factories and may greatly contribute to the automation and intelligence of production lines. In particular, feedback control based on the prediction results of embodiments may be possible, enabling real-time optimization of process conditions. The real-time optimization through feedback control may greatly improve product quality uniformity

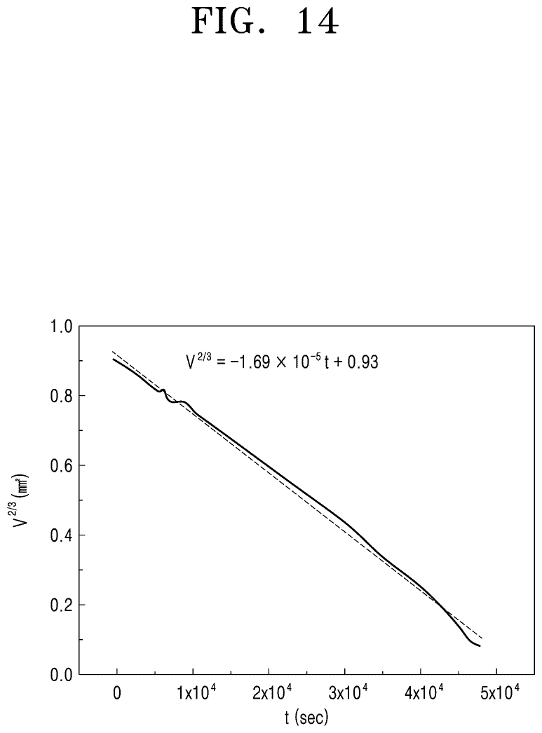

FIG. 14 is an embodiment of a time-surface area (volume to the ⅔ power) graph with actual conditions applied. For reference, the graph in FIG. 14 may be acquired through an experiment performed under atmospheric pressure and room temperature conditions.

The graph in FIG. 14 shows volume V to the ⅔ power (y-axis in FIG. 14) as a function of time t (x-axis in FIG. 14). Since volume V raised to the ⅔ power is proportional to the surface area of the droplet, when a linear equation between V raised to the ⅔ power and time t is derived, the relationship between the surface area of the droplet and time t may be acquired.

According to the graph in FIG. 14, the linear equation below may be derived.

$$\begin{matrix}[ Formula 9 ] & \\ {V}^{2 / 3} = - 1.69 \times {10}^{- 5} t + 0.93 & \end{matrix}$$

In Formula 9, V is the volume of the droplet and the unit may be cubic millimeter (mm³), and t is time and the unit may be second (sec).

Formula 10 below is obtained by differentiating [Formula 9] and applying it to [Formula 8].

$$\begin{matrix}[ Formula 10 ] & \\ \frac{d}{dt} ( {V}^{\frac{2}{3}} ) = \frac{d}{dt} ( - 1.69 \times {10}^{- 5} t + 0.93 ) & ( 1 )\end{matrix}$$

$$\frac{2}{3} {V}^{- 1 / 3} \frac{dV}{dt} = - 1.69 \times {10}^{- 5} \qquad ( 2 )$$

$$\frac{dV}{dt} = - 2.54 \times 1 {-}^{- 5} {V}_{t}^{\frac{1}{3}} \qquad ( 3 )$$

$$\frac{π {r}_{t} Dcs}{ρ} f ( {ϑ}_{t} ) = 2.54 \times {10}^{- 5} {V}_{t}^{\frac{1}{3}} \qquad ( 4 )$$

Formulas 9 and 10 may be understood as embodiments of applying Formula 8 by utilizing actual conditions. Values of rₜ, ρ, f(θₜ₋₁), and Vₜ in Formula 10 may be acquired through measurement.

Hereinafter, an inkjet printing method utilizing the method and system for predicting drying behavior of droplets described in this specification will be described.

The inkjet printing method may provide higher material efficiency than conventional vacuum deposition and photolithography processes, may enable digital control and non-contact printing, and may provide advantages of forming patterns on large-area substrates without using a fine metal mask. The inkjet printing process may be used in manufacturing processes of organic light-emitting display devices, such as thin film encapsulation layer manufacturing processes or common layer and light-emitting layer manufacturing processes. Additionally, the inkjet printing process may be used in quantum dot formation processes during manufacturing processes of Quantum Dot Display (“QDD”) devices.

When using the inkjet printing method, drying behavior of ink is important, and the method and system for predicting drying behavior of droplets described above may be utilized to examine the drying behavior of ink. As a result of utilizing the method and system for predicting drying behavior of droplets, characteristics of the composition type and ratio of ink to be used in the inkjet printing method may be determined, or atmospheric pressure conditions of the environment in which the inkjet printing method is applied may be determined.

In an embodiment, Case A may refer to a case when composition characteristics of ink (e.g., composition type and composition ratio) are A1 and condition characteristics for the display panel manufacturing environment (e.g., pressure conditions and temperature conditions) are A2, for example. Similarly, Case A′ may refer to a case when composition characteristics of ink are A1 and condition characteristics for the manufacturing environment are A2′. By utilizing the above-described method and system for predicting droplet drying behavior, more advantageous manufacturing environment condition characteristics between Case A and Case A′ may be derived using the neural network model described above. The neural network model may predict occurrence of dewetting phenomena or coffee ring effects (phenomenon where the edge of the droplet remains darker after drying) after the droplets of Case A and Case A′ are dried by deriving contact angle information and contact radius information of the droplet.

In an embodiment, Case B may refer to a case when composition characteristics of ink (e.g., composition type and composition ratio) are B1 and condition characteristics for the display panel manufacturing environment (e.g., pressure conditions and temperature conditions) are B2, for example. Similarly, Case B′ may refer to a case when composition characteristics of ink are B1′ and condition characteristics for the manufacturing environment are B2. By utilizing the method and system for predicting drying behavior of droplets described above, more advantageous ink composition characteristics between Case B and Case B′ may be derived using the neural network model. When contact angle information and contact radius information of the droplet are derived through the neural network model, it may be possible to predict whether dewetting phenomena or coffee ring effects (phenomenon where the edge of the droplet remains darker after drying) occur after the droplets of Case B and Case B′ are dried.

Embodiments propose innovative prediction methods utilizing artificial intelligence technology, breaking away from traditional experimental approaches. The artificial intelligence-based prediction methods may suggest future directions of display manufacturing technology development and lead technological innovation in related industries. The prediction methods in embodiments may have universal applicability regardless of the type or composition of droplets, and even when new compositions of ink or solutions are developed, reliable drying behavior prediction may be possible with minimal learning data.

In addition, the methods may enable much more accurate and reliable predictions than existing empirical approaches or simple simulations, which may contribute to accelerating the Digital Transformation of manufacturing processes.

Embodiments may be modeled as computer-readable code on a medium in which a program is recorded. Computer-readable media may include any type of recording device that stores data that may be read by a computer system. Computer-readable media includes any type of recording device that stores data that may be read by a computer system. In embodiments, computer-readable media may include Hard Disk Drives (“HDDs”), SSDs, SDDs, ROM, RAM, Compact Disc Read-Only Memory (“CD-ROM”), magnetic tapes, floppy disks, optical data storage devices, and those modeled in the form of carrier waves (e.g., transmission over the Internet). Accordingly, the above detailed description should be considered illustrative and not restrictive in all features. The scope of the disclosure should be determined by reasonable interpretation of the appended claims, and all changes within the equivalent scope of the disclosure are intended to be embraced within the scope of the disclosure.

Although embodiments have been described with reference to the drawings shown, these are merely exemplary, and those skilled in the art will understand that various modifications and equivalent other embodiments are possible therefrom. Therefore, the true technical protection scope of embodiments should be determined by the technical idea of the appended claims.

By embodiments, a method and system capable of quickly and accurately predicting the drying behavior of droplets using a learned network model may be implemented. Of course, the scope of embodiments is not limited by these effects.

It should be understood that embodiments described herein should be considered in a descriptive sense only and not for purposes of limitation. Descriptions of features or advantages within each embodiment should typically be considered as available for other similar features or advantages in other embodiments. While embodiments have been described with reference to the drawing figures, it will be understood by those of ordinary skill in the art that various changes in form and details may be made therein without departing from the spirit and scope as defined by the following claims.

What is claimed is:

1. A method for predicting a drying behavior of a droplet, the method comprising:
acquiring learning data for a reference droplet;
performing a learning process on the learning data using a neural network model;
acquiring input data for a target droplet; and
acquiring output data for the input data using the neural network model,
wherein the learning data comprises:
a first dataset acquired for the reference droplet according to a time series in a first pressure state; and
a second dataset acquired for the reference droplet according to a time series in a second pressure state,
wherein each of the first dataset and the second dataset comprises:
information on a pressure applied to the reference droplet;
contact angle information of the reference droplet; and
contact radius information of the reference droplet,
wherein the input data comprises:
a third dataset acquired at a plurality of points in time for the target droplet in a third pressure state, the third dataset comprising:
information on a pressure applied to the target droplet;
contact angle information of the target droplet; and
contact radius information of the target droplet, and
wherein the output data comprises:
contact angle information and contact radius information of the target droplet at a future point in time in the third pressure state.

2. The method according to claim 1,
wherein the reference droplet and the target droplet comprise a same material as each other.

3. The method of claim 1,
wherein the neural network model comprises a Long Short-Term Memory.

4. The method of claim 3,
wherein the acquiring the learning data comprises:
acquiring the information on the pressure applied to the reference droplet;
acquiring first images of the reference droplet a plurality of times over time; and
acquiring contact angle information and contact radius information of the reference droplet a plurality of times based on the first images.

5. The method of claim 4,
wherein the first images comprise:
first-1st images of the reference droplet taken in a reference direction perpendicular to a floor surface on which the reference droplet is disposed; and
first-2nd images of the reference droplet taken in a direction intersecting the reference direction.

6. The method of claim 5,
wherein the acquiring the contact angle information and the contact radius information of the reference droplet the plurality of times comprises:
acquiring contact radius information of the reference droplet from the first-1st images; and
acquiring contact angle information of the reference droplet from the first-2nd images.

7. The method of claim 6,
wherein the acquiring the input data for the target droplet comprises:
acquiring the information on the pressure applied to the target droplet;
acquiring second images of the target droplet a plurality of times over time; and
acquiring contact angle information and contact radius information of the target droplet a plurality of times based on the second images.

8. The method of claim 7,
wherein the second images comprise:
second-1st images of the target droplet taken in the reference direction perpendicular to the floor surface on which the target droplet is disposed; and
second-2nd images of the target droplet taken in the direction intersecting the reference direction.

9. The method of claim 8,
wherein the contact radius information of the target droplet is acquired from the second-1st images.

10. The method of claim 8,
wherein the contact angle information of the target droplet is acquired from the second-2nd images.

11. The method of claim 1,
wherein, when the third pressure state is the first pressure state, the output data is acquired based on the first dataset, and
wherein, when the third pressure state is the second pressure state, the output data is acquired based on the second dataset.

12. A system for predicting a drying behavior of a droplet, the system comprising:
a chamber configured to accommodate a reference droplet or a target droplet therein;
a vacuum pump configured to control a pressure within the chamber;
a camera device configured to capture images of an interior of the chamber; and
a computing device configured to:
control the vacuum pump and the camera device,
acquire learning data for the reference droplet,
perform a learning process on the learning data using a neural network model,
acquire input data for the target droplet, and
acquire output data for the input data using the neural network model,
wherein the learning data comprises:
a first dataset acquired for the reference droplet according to a time series in a first pressure state; and
a second dataset acquired for the reference droplet according to a time series in a second pressure state,
wherein each of the first dataset and the second dataset comprises:
information on a pressure applied to the reference droplet;
contact angle information of the reference droplet; and
contact radius information,
wherein the input data comprises:
a third dataset acquired at a plurality of points in time for the target droplet in a third pressure state, the third dataset comprising:
information on a pressure applied to the target droplet;
contact angle information of the target droplet; and
contact radius information, and
wherein the output data comprises:
contact angle information and contact radius information of the target droplet at a future point in time in the third pressure state.

13. The system of claim 12,
wherein the reference droplet and the target droplet comprise a same material as each other.

14. The system of claim 12,
wherein the neural network model comprises a Long Short-Term Memory.

15. The system of claim 12,
wherein the computing device is further configured to:
acquire the information on the pressure applied to the reference droplet;
acquire first images of the reference droplet a plurality of times over time; and
acquire contact angle information and contact radius information of the reference droplet a plurality of times based on the first images.

16. The system of claim 15,
wherein the first images comprise:
first-1st images of the reference droplet taken in a reference direction perpendicular to a floor surface on which the reference droplet is disposed; and
first-2nd images of the reference droplet taken in a direction intersecting the reference direction.

17. The system of claim 16,
wherein the computing device is further configured to:
acquire contact radius information of the reference droplet from the first-1st images; and
acquire contact angle information of the reference droplet from the first-2nd images.

18. The system of claim 16,
wherein the computing device is further configured to:
acquire the information on the pressure applied to the target droplet;
acquire second images of the target droplet a plurality of times over time; and
acquire contact angle information and contact radius information of the target droplet a plurality of times based on the second images.

19. The system of claim 18,
wherein the second images comprise:
second-1st images of the target droplet taken in the reference direction perpendicular to the floor surface on which the target droplet is disposed; and
second-2nd images of the target droplet taken in the direction intersecting the reference direction.

20. The system of claim 19,
wherein the computing device is further configured to:
acquire contact radius information of the target droplet based on the second-1st images; and
acquire contact angle information of the target droplet based on the second-2nd images.
